(19) United States
(12) Patent Application Publication
(10) Pub. No.: US 2015/0215390 A1
(43) Pub. Date: Jul. 30, 2015

(54) Apparatus and Method for Multi-User Editing of Computer-Generated Content

(71) Applicant: Crytek GmbH, Frankfurt/Main (DE)

(72) Inventor: Cevat Yerli, Frankfurt/Main (DE)

(21) Appl. No.: 14/168,335

(22) Filed: Jan. 30, 2014

(51) Int. Cl. H04L 29/08; G06F 3/0484

(52) U.S. Cl. CPC H04L 67/104; G06F 3/0484

(57) ABSTRACT

An apparatus and a machine-readable medium are described. The apparatus comprises an I/O adapter configured to couple to at least first and second user clients, memory configured to store data of computer-generated content, and circuitry coupled to the I/O adapter and the memory. The circuitry is configured to transmit a first copy of a portion of the stored data of the computer-generated content to the first user client and a second copy of the portion to the second user client, such that the first and second user clients can modify the first and second copy of the portion, respectively, at the same time and independently from each other, to receive a modified first copy from the first user client and a modified second copy from the second user client, and to update the data stored in the memory using the modified first and second copies.

### FIELD

The present disclosure relates to the field of editing and modifying computer-generated content, such as computer-generated scenes for a computer game, an animation or a movie.

### BACKGROUND

When using common editing techniques known in the art to modify computer-generated (CG) content for a game, an animation, or a movie, only one user can edit the content at a time. This limits the production process for the CG content, as editors have to work in shifts, one after the other. Moreover, known techniques are usually limited to only one hardware platform. Using only one platform, however, limits the possibilities of switching the platform either in an ongoing production or later when switching to new hardware equipment, as the software used for editing the content is mostly not compatible with different hardware specifications or platforms.

Moreover, when different output signals for different display types are desired, the output signals are usually rendered one after the other, thus limiting the capabilities to review the CG content.

It is therefore desirable to allow a more efficient and flexible editing of CG content.

### SUMMARY AND INITIAL DISCLOSURE

In a first aspect, an apparatus for allowing a plurality of users to modify computer-generated content, such as a computer-generated scene, is provided. The apparatus comprises an I/O adapter configured to couple to at least first and second user clients, a memory configured to store data about the computer-generated content, and circuitry operatively coupled to the I/O adapter and the memory. The circuitry is configured to transmit a first copy of a portion of the stored data of the computer-generated content to the first user client and a second copy of the portion to the second user client, such that the first and second user clients can modify the first and second copy of the portion, respectively, at the same time and independently from each other. The circuitry is further configured to receive a modified first copy from the first user client and a modified second copy from the second user client, and to update the data of the computer-generated content stored in the memory using the modified first and second copies.

The apparatus according to the present disclosure therefore allows at least two users, operating at respective user clients, to work independently from each other on the same computer-generated content at the same time. Hence, the users, such as editors, designers, etc., may work in a timely overlapping manner, such that the process of editing and modifying the computer-generated content is faster and more efficient. Each user may modify their own copy of the portion of the CG content data locally on their user client. When a user has completed his or her work on the local copy of the data portion, he or she may upload the modified local copy to the apparatus according to some embodiments of the disclosure. In some embodiments, the circuitry may be adapted to receive modified first and second copies from the first and second user client, respectively, multiple times, such as, e.g., on a periodic basis. The apparatus may, e.g., transmit the first and second copies to the user clients via the I/O adapter and may receive the modified copies from the user clients via the I/O adapter.

The I/O adapter may be configured to couple to the first and second user clients in a wired or wireless manner, for example, via a local area network, an intranet, and/or the Internet.

The memory may comprise any type of volatile or non-volatile memory, such as one or more hard disks, optical disks, magnetic disks, magneto-optical disks, semiconductor memories, such as flash memories, etc. The circuitry may, in some embodiments, comprise a processor, such as a central processing unit (CPU), a graphics processor, a specific-purpose processor or a general-purpose processor.

In some embodiments, the I/O adapter is further configured to couple to additional user clients, and the circuitry is configured to transmit additional copies of the portion of the stored data to the additional user clients, to receive modified additional copies from the additional user clients, and to use the modified additional copies when updating the data of the computer-generated content stored in the memory.

In some embodiments, the circuitry is configured to transmit the first copy of the portion of the stored data to the first user client in response to receiving a request for a copy of the portion of data from the first user client. Similarly, the circuitry may be configured to transmit the second copy of the portion of data to the second user client in response to receiving a request for a copy of the portion of data from the second user client.

In some embodiments, the circuitry may be configured to transmit the first and second copies concurrently or in a timely overlapping manner. In other embodiments, the circuitry may be adapted to transmit the first copy to the first user client before transmitting the second copy to the second user client, or to transmit the second copy to the second user client before transmitting the first copy to the first user client. In some embodiments, the circuitry may receive the modified first copy from the first user client before receiving the modified second copy from the second user client, or vice versa.

In some embodiments, the circuitry may be configured to update the data of the computer-generated content stored in the memory using the modified first copy in response to receiving the modified first copy. Alternatively or additionally, the circuitry may be configured to update the data of the computer-generated content stored in the memory using the modified second copy in response to receiving the modified second copy from the second user client. However, it is preferred that the circuitry is configured to update the data stored in the memory using the modified first and second copies after having received each of the modified first and second copies. This allows the circuitry to aggregate the modified first and second copies before updating the data stored in the memory, and to use the aggregated modified first and second copies to update the stored data.

The phrase “at the same time,” in the context of this disclosure, may refer to a timely overlapping manner. In other words, the user clients may operate on the first and second copy, respectively, e.g., concurrently or partially concurrently. Generally, this refers to a situation in which, after the first copy has been transmitted to the first user client, the second copy is transmitted to the second user client, before the modified first copy has been received from the first user client, such that both user clients have copies of the same data portion at the same time. This does not necessarily imply that the first and second copies are transmitted simultaneously, or that the modified first and second copies are received simultaneously, or that a first user and a second user actually operate the first user client and the second user client, respectively, simultaneously.

In general, computer-generated (CG) content may e.g. refer to CG content for a game, an animation, or a movie. In particular, the computer-generated content may refer to a game level in a computer game, such as, e.g., an online or offline computer game. While the computer-generated content may in some instances be 2D content, it is preferred that the CG content is 3D content.

According to at least one embodiment, the data of the computer-generated content stored in the memory includes at least one list of changes, and the circuitry is further configured, in response to receiving the modified first copy from the first user client and before receiving the modified second copy from the second user client, update the at least one list of changes using the received modified first copy, and transmit a notification to the second user client that the modified first copy of the portion of data has been received from the first user client. For example, the first user operating the first user client may have completed his or her work on the first copy, or may otherwise desire to save his or her modifications to the data portion. The first user then uploads the modified first copy to the apparatus. As the first and second copies correspond to the same portion of the stored data, the modifications carried out by the first user on the first copy may also affect the work of the second user on the second copy. Therefore, this embodiment allows the second user to be notified about the modifications carried out by the first user.

In some embodiments, the notification comprises a notice saying that a modified copy of the portion of data has been received from the first user client. Additionally, in some embodiments, the notification comprises further details of the modified first copy, such as a list or details of modifications included in the modified first copy, or even an entirety of the modified first copy. The second user operating the second user client may then assess the notification to determine whether the modifications carried out by the first user in the modified first copy affect the second user's work on the second copy of the data portion. If yes, the second user may, e.g., decide to carry out additional modifications based on the modified first copy from the first user copy to obtain the modified second copy. Alternatively, the second user may decide to continue working on the second copy of the data portion retrieved from the memory and previously sent by the apparatus, i.e., without the modifications by the first user. In some embodiments, the second user is enabled to integrate some elements, objects or modifications included in the modified first copy but not in the second copy previously transmitted to the second user client, into the modified second copy and may further carry out additional modifications. In that case, the modified second copy will include some or all modifications included in the modified first copy and may further include additional modifications by the second user client.

Updating the at least one list of changes using the received modified first copy may, e.g., comprise including the modified first copy or a part thereof in the list of changes. For example, modifications carried out in the modified first copy in comparison to the first copy previously transmitted to the first user client or a reference thereto may be added to the list of changes. In some embodiments, additionally, an identification of the first user client, an identification of a first user operating the first user client, a time of receiving the modified first copy, or the like may also be included when updating the list of changes.

In another embodiment, the circuitry is further configured, in response to transmitting the notification to the second user client, to receive confirmation information regarding the modified first copy from the second user client, and to store the received confirmation information in the at least one list of changes. In this embodiment, the second user operating the second user client may indicate that he approves or disapproves the modified first copy or a part thereof, such as, e.g., only some of the modifications, objects, or assets included in the modified first copy but not included in the second copy previously transmitted to the second user client. Hence, the confirmation information may comprise an approval or disapproval of the modified first copy or a part thereof. The confirmation information, such as approval or disapproval information, may be stored in the list of changes, e.g., along with the modified first copy or modifications included in the modified first copy. Hence, other users may easily see that the second user has approved or disapproved modifications carried out by the first user operating the first user client.

The I/O adapter may also be configured to couple to a lead user client, and the circuitry may be further configured to transmit the at least one list of changes to the lead user client and, in response to receiving an approval indication for at least a part of the at least one list from the lead user client, update the portion of the data of the computer-generated content stored in the memory based on the approval indication. In this embodiment, the lead user operating the lead user client may approve or disapprove the list of changes or a part thereof, such as individual modifications, assets, or objects. The list of changes comprises, e.g., the modified copies received from user clients, such as, e.g., the modified first copy received from the first user client and/or the modified second copy received from the second user client, or only modifications included in the modified copies over the copies previously transmitted to the user clients, or references to these modifications.

In addition, as set forth above, the list of changes may in some embodiments further comprise confirmation information from other users. Hence, the lead user may assess the list of changes including the modified copies, or the modifications included therein, and the confirmation information from other users, to decide whether a modified copy included in the list or a part thereof, such as individual modifications or layers, should be used to update the data of the computer-generated content stored in the memory. In some embodiments, the lead user may approve or disapprove a modified copy included in the list of changes as a whole, or alternatively, may approve or disapprove a part of a modified copy, such as individual modifications or layers of the modified copy.

According to another embodiment, the first copy of the portion of data transmitted to the first user client corresponds to a first perspective, and the second copy of the portion of data transmitted to the second user client corresponds to a second perspective different from the first perspective. For example, the CG content may be 3D content, and the first and second perspectives may correspond to different viewpoints and/or different viewing angles. Hence, the first and second users may review and modify different views of the same portion of the CG content data.

In another embodiment, the I/O adapter is further configured to couple to at least first and second viewing clients, and the circuitry is further configured to transmit a third copy of the portion of data corresponding to a third perspective to the first viewing client, and a fourth copy of the portion of data corresponding to a fourth perspective different from the third perspective to the second viewing client. The viewing clients may, e.g., be used to view or review the CG content or a part thereof. Hence, this embodiment allows the first and second viewing clients to review the CG content from different viewpoints or viewing angles, etc.

According to another embodiment, the circuitry is configured to transmit the first and second copies in a platform-independent format. In this embodiment, different user clients having different hardware specifications and/or different platforms can be used to modify the computer-generated content, without any need to convert the copies locally to another format. Hence, the flexibility and efficiency of the editing process is enhanced.

According to another embodiment, the first copy is transmitted to the first user client prior to transmitting the second copy to the second user client, and the circuitry is further configured to transmit, along with the second copy, an indication to the second user client that a layer of the second copy may not be modified by the second user client. The circuitry may be configured, after receiving the modified second copy, to disregard the layer of the modified second copy when updating the data stored in the memory. According to this embodiment, the second user operating the second user client will be warned that another user is currently working on a layer of the data and that, to avoid conflicts, the second user is not allowed to modify that layer. As a specific example, the first user may be working on the lighting of the CG content, and have already received the first copy of the data portion from the apparatus. When, afterwards, the second user client receives the second copy of the same data portion, the second user will be notified that he or she is not allowed to modify a layer of the second copy corresponding to the lighting in that portion of data.

The layer may correspond to at least one of character data, vfx data, audio data, metadata, editorial data, and environmental data. The character data may, e.g., comprise data about a character in the CG scene, for example, referring to a character's outer appearance and/or personality traits. The environmental data may comprise, e.g., light characteristics, such as a number of light sources, a position of a light source, a size of a light source, a color of light and/or an intensity of light, and/or weather characteristics, such as a level of fogginess, a level of dampness, a level of rainfall, a visibility range, and/or a level of snowfall.

In a further aspect, the present disclosure provides a non-transitory, machine-readable medium having instructions stored thereon that, when executed by a machine, cause the machine to perform a method. The method comprises transmitting a first copy of a portion of data of computer-generated content, such as a computer-generated scene, stored in a memory to a first user client and a second copy of the portion of data to a second user client, such that the first and second user clients can modify the first and second copy of the portion, respectively, at the same time and independently from each other. The method further comprises receiving a modified first copy from the first user client and a modified second copy from the second user client, and updating the data stored in the memory using the modified first and second copies.

According to at least one embodiment, the first and second copies of the portion of data are transmitted in a 3D format. Similarly, in embodiments in which third and fourth copies of the portion are transmitted to first and second viewing clients, respectively, the third and fourth copies of the portion of data may be transmitted in a 3D format.

In some embodiments, the step of transmitting the first copy of the portion of data to the first user client is in response to receiving a request for a copy of the portion of data from the first user client. Similarly, the step of transmitting the second copy of the portion of data to the second user client may be in response to receiving a request for a copy of the portion of data from the second user client.

In some embodiments, the circuitry may be adapted to receive the modified first copy before, after, or at the same time as receiving the modified second copy from the second user client. Generally, the circuitry is configured to transmit the first and second copies of the data portion via the I/O adapter, and to receive the modified first and second copies of the data portion via the I/O adapter. Also, the circuitry may be adapted to receive a request for a copy of a data portion via the I/O adapter.

In another embodiment, the data of the computer-generated content stored in the memory includes at least one list of changes, and the method further comprises, in response to receiving the modified first copy from the first user client and before receiving the modified second copy from the second user client, updating the at least one list of changes using the received modified first copy, and transmitting a notification to the second user client that the modified first copy of the portion of data has been received from the first user client.

In another embodiment, the method further comprises in response to transmitting the notification to the second user client, receiving confirmation information regarding the modified first copy from the second user client, and storing the received confirmation information in the at least one list of changes.

According to another embodiment, the method further comprises transmitting the at least one list of changes to a lead user client and, in response to receiving an approval indication for at least a part of the at least one list from the lead user client, updating the portion of the data of the computer-generated content stored in the memory based on the approval indication.

In another embodiment, the first copy of the portion of data transmitted to the first user client corresponds to a first perspective and the second copy of the portion of data transmitted to the second user client corresponds to a second perspective different from the first perspective.

In another embodiment, the method further comprises transmitting a third copy of the portion of data corresponding to a third perspective to a first viewing client, and a fourth copy of the portion of data corresponding to a fourth perspective to a second viewing client.

According to another embodiment, the first and second copies are transmitted in a platform-independent format.

In another embodiment, the first copy is transmitted to the first user client prior to transmitting the second copy to the second user client and the method further comprises: transmitting, along with the second copy, an indication to the second user client that a layer of the second copy may not be modified by the second user client. It is, in particular, preferred that the method further comprises disregarding the layer of the modified second copy when updating the data stored in the memory, after receiving the modified second copy from the second user client.

In another embodiment, the layer corresponds to at least one of character data, vfx data, audio data, metadata, editorial data, and environmental data. The environmental data may, e.g., comprise light characteristics, such as a number of light sources, a position of a light source, a size of a light source, a color of light and/or an intensity of light, and weather characteristics, such as a level of fogginess, a level of dampness, a level of rainfall, a visibility range, and/or a level of snowfall.

In yet a further aspect, the present disclosure provides a system comprising an apparatus of the above-mentioned kind and at least a first user client and a second user client coupled to the I/O adapter of the apparatus. The first and the second user clients may include, independently from each other, a computing device, such as a personal computer (PC), a tablet computer, a smartphone, a personal digital assistant (PDA), a workstation, a laptop computer, a netbook computer, a game console development kit, such as an Xbox 360® development kit, a PlayStation 3D development kit, or any other kind of device that may be used to modify or edit a portion of computer-generated content. The first and second user clients may, independently from each other, include one or more displays, such as one or more 2D displays and/or one or more 3D displays.

In some embodiments, the system further comprises at least a first viewing client coupled to the I/O adapter of the apparatus, wherein the first viewing client comprises a display for showing a copy of a data portion, such as a 2D or a 3D display.

The first and second user clients may, independently from each other, be configured to transmit a request for a copy of a data portion to the apparatus, e.g., in response to receiving a fetch command from first and second users, respectively. The fetch command may, for example, comprise the first or second user, respectively, selecting a button on a display of the first or second user client, respectively.

In some embodiments, the first and second user clients may, independently from each other, be coupled with the I/O adapter of the apparatus in wired or wireless communication. For example, the first and/or the second user client may comprise a LAN adapter, a WLAN adapter, or another type of interface for coupling to the I/O adapter of the apparatus.

### DESCRIPTION OF THE DRAWINGS

Further features and benefits of the present disclosure will become apparent to the skilled person when reading the following detailed description in conjunction with the accompanying figures, in which:

FIG. 1 shows a schematic diagram of the system according to an embodiment;

FIG. 2 shows another schematic diagram of an embodiment of the system;

FIG. 3 shows a structure of data stored in the memory according to an embodiment;

FIGS. 4A-4C show a flow diagram of a method according to an embodiment; and

FIG. 5 shows a schematic view of the system according to an embodiment.

### DETAILED DESCRIPTION

Throughout the following description and in the accompanying figures, like reference numerals will be used to denote like elements.

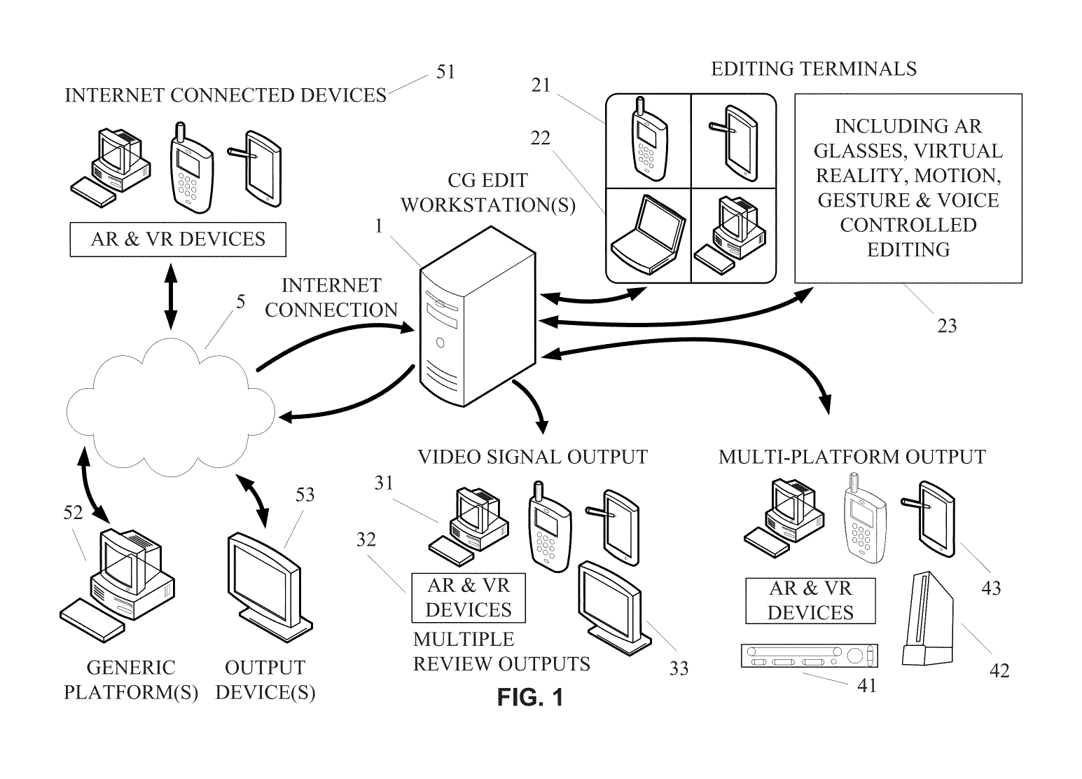

FIG. 1 shows a schematic view of a system according to an embodiment. The system comprises an apparatus 1, which in the embodiment of FIG. 1 is a computer-generated (CG) content edit workstation. The CG edit workstation comprises an I/O adapter (not shown) for coupling the CG edit workstation 1 to a plurality of user clients, referred to as editing terminals 21, 22, 23 in the embodiment of FIG. 1. As illustrated in FIG. 1, the editing terminals may each comprise one of a variety of devices, such as personal computers, laptops, PDAs, mobile phones, smartphones, and/or augmented reality (AR) devices, such as AR glasses. In particular, the editing terminals may allow for virtual reality (VR), such as motion-, gesture-, and voice-controlled editing, but are not limited in this regard.

The editing terminals 21, 22, 23 allow respective users to request copies of a data portion stored in a memory (not shown) of the CG edit workstation 1. After receiving the request from the editing terminals 21, 22, 23, the CG edit workstation 1 transmits a copy of the requested data portion to each of the terminals 21, 22, 23. The users operating the editing terminals 21, 22, 23 may then modify their respective (local) copy of the data portion independently from each other and at the same time. When a user operating one of the editing terminals 21, 22, 23 has completed his or her work on the local copy of the data portion, the user may transmit the modified copy of the data portion back to the CG edit workstation 1. In some embodiments, the user may also transmit the modified copy at any desired time during his or her work, or even repeatedly, as the user's work progresses. For example, a modified copy of the data portion may be transmitted to the workstation on a periodic basis, such as, e.g., with a period of between 5 minutes and 3 hours, in particular between 10 minutes and 2 hours and, preferably, between 30 minutes and 1 hour.

In addition to the editing terminals 21, 22, 23 coupled to the CG edit workstation 1, a number of review outputs 31, 32, 33 are coupled to the I/O adapter of the CG workstation 1. The review outputs 31, 32, 33 may be viewing clients, each comprising at least one display for showing a data portion of the CG content received from the CG edit workstation 1, e.g., in form of a media stream, such as a video and/or audio stream. In particular, the review outputs 31, 32, 33 may refer to different types of outputs, possibly comprising different types of display. For example, some of the review outputs 31, 32, 33 used as viewing clients may comprise a liquid crystal display (LCD), a projector, a plasma TV, a light emitting diode (LED) display, a cathode ray tube (CRT) display, a touch-sensitive display, etc. The review outputs 31, 32, 33 may comprise video signal output devices, such as computers, mobile phones, PDAs or displays, such as computer or TV screens, and may, in some instances, comprise augmented reality (AR) and virtual reality (VR) devices, but are not limited in this regard. AR and VR devices may e.g. support motion-, gesture-, and/or voice-controlled output of a CG content.

The CG edit workstation 1 is further coupled to multiple platforms, generally indicated by reference numerals 41, 42, 43 in FIG. 1. The multiple platforms may, e.g., comprise one or more personal computers (PCs), tablet computers, gaming consoles, such as Xbox 360® PlayStation 3D, etc., TV screens, projectors, netbooks, laptops, mobile phones, smartphones, etc. The multiple platforms receive the CG content from the CG edit workstation 1 and output the CG content. In some cases, the platforms 41, 42 and 43 may comprise AR and VR devices, but are not limited in this regard. The platforms 41, 42 and 43 may run respective application programs to render and display the CG content. Additionally, the platforms 41, 42 and 43 may communicate bidirectionally with the CG edit workstation 1, such that they may send data back to the CG edit workstation 1.

Moreover, the CG edit workstation 1 is also coupled to the Internet 5 via an Internet connection. The Internet connection provides additional connectivity for the CG edit workstation 1, for example, to one or more Internet connected devices 51, one or more generic platforms 52 and/or one or more output devices 53. The Internet connected devices 51 may, e.g., comprise AR and VR devices, but are not limited in this regard. The Internet connected devices 51, the one or more generic platforms 52, and/or one or more output devices 53 may communicate bidirectionally with the CG edit workstation 1, such that they may send data back to the CG edit workstation 1.

In general, the editing terminals 21, 22, 23 allow editors, i.e., users, to edit or modify data of the CG content and collaborate on the construction and modification of the content. The terminals 21, 22, 23 fetch copies of the required data portion from the CG edit workstation 1 and transmit back modified, updated copies of the data.

The CG edit workstation 1 stores the CG content data in a memory and manages the data. The workstation 1 transmits copies of the requested data portion to the editing terminals 21, 22, 23 and updates its memory using the modified copies of the data portions transmitted from the editing terminals 21, 22, 23. The workstation 1 further handles conflicting data resulting from conflicting modified copies from the editing terminals 21, 22, 23 without data loss and, in some embodiments, updates the editing terminals 21, 22, 23 instantly in real time when a modified copy is received from one of the other terminals. The workstation 1 may also output the updated content data to any or all connected outputs, e.g., viewing clients, and platforms in the necessary data format.

The multiple platforms 41, 42, 43 receive copies of a data portion from the CG edit workstation 1 in an appropriate format to be rendered and displayed on the platforms 41, 42, 43. The transmitted copy of the data portion may be constantly transferred and updated and thus reflects any change made to the content at the CG edit workstation 1.

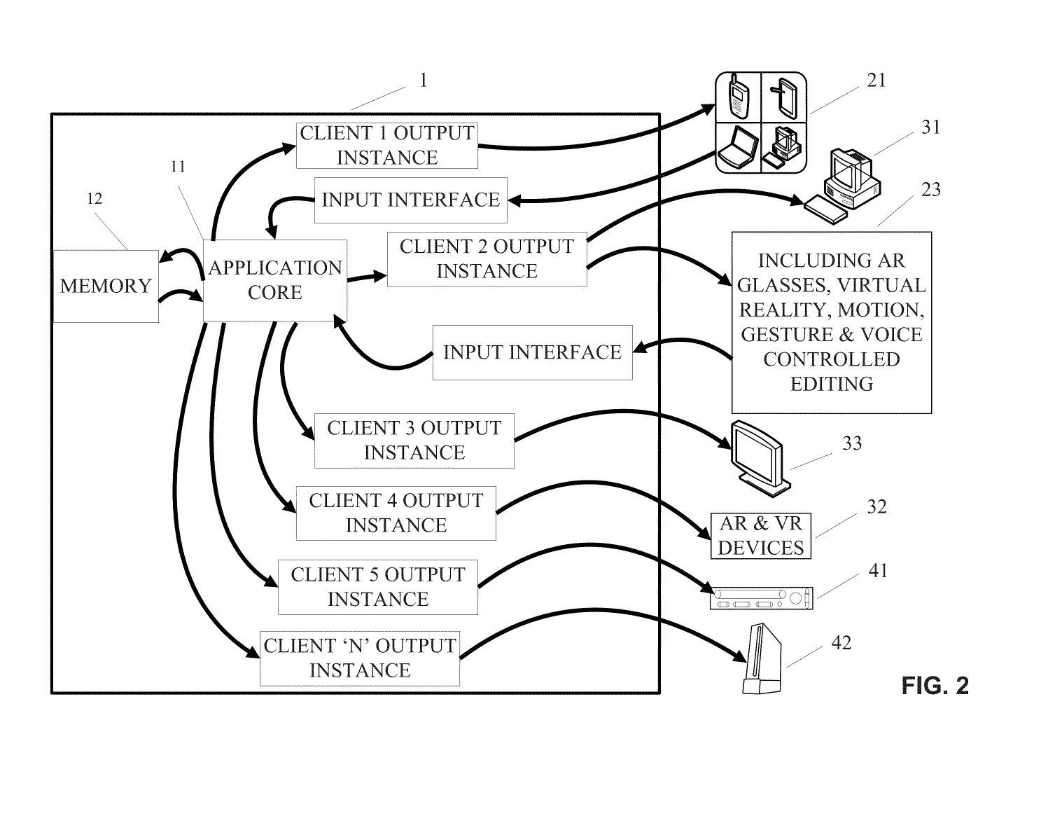

FIG. 2 shows another schematic view of a system according to an embodiment including an apparatus 1, which may, e.g., be the CG edit workstation shown in FIG. 1. As shown in FIG. 2, the apparatus 1 handles each connected user client 21, 23 and output device 31, 32, 33 separately. For example, different portions of the content data may be transmitted to each of the user clients 21, 23; the viewing clients 31, 32, 33; and the platforms 41, 42. Moreover, the apparatus 1 may also provide the clients 21, 23, 31-33 with copies of the same data portion corresponding to different perspectives, such as different viewpoints and/or different viewing angles. For example, each of the user clients 21, 23 may be provided with a respective copy of the same data portion corresponding to different perspectives, such that each user client 21, 23 may modify different views of the same CG content, e.g., taken from different perspectives.

As can also be seen from FIG. 2, each client accessing the CG content data does so via an application core 11 of the apparatus 1. In this embodiment, any change a user client applies goes through the application core 11 and is stored in a memory 12 of the apparatus 1, which is operatively coupled to the application core 11. In some embodiments, each client constantly receives updates of the current data stored in the memory 12 and thus can see if objects are currently being modified by other clients. These objects (or layers) may be locked as long as they are modified by one user client.

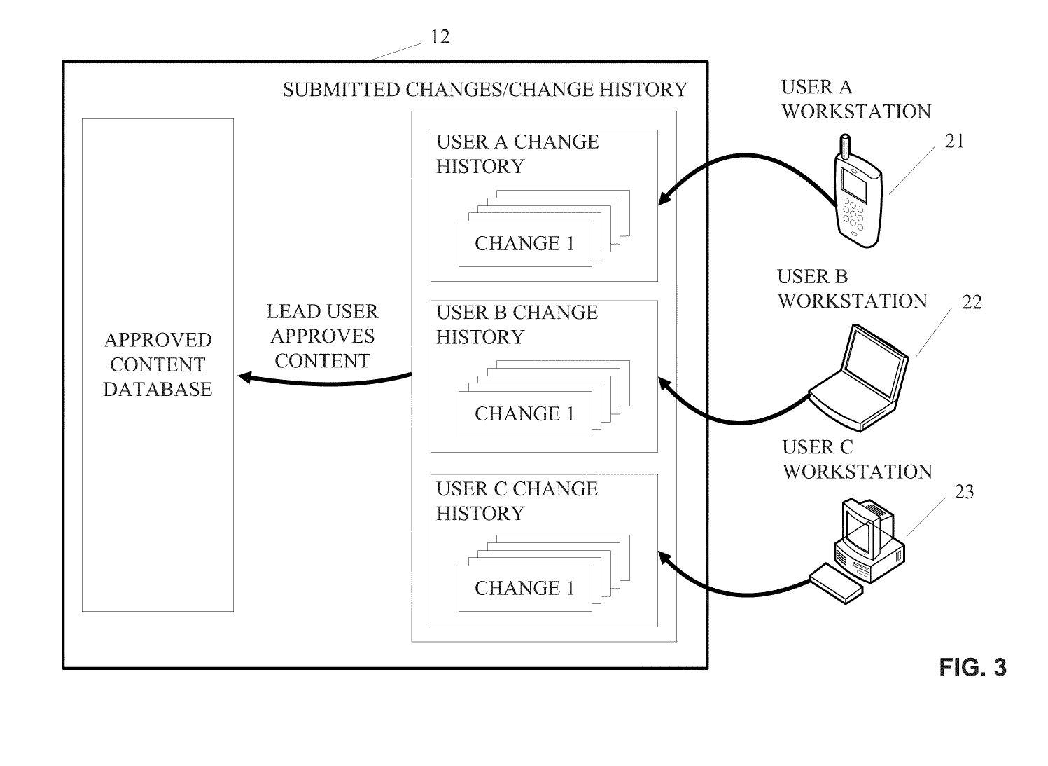

FIG. 3 shows a schematic view of how data are organized in the memory 12 of an apparatus, such as the workstation 1 in the embodiment of FIG. 1. The apparatus saves a history of each user's modifications as a list of changes, referred to as “submitted changes/change history” in FIG. 3. In particular, the memory 12 may store a list of changes for each user or each user client registered with the apparatus 1. The lists of changes of the different user clients or users may be organized in layers. First, all changes are executed on the user client of the respective user, and are then transmitted to the apparatus. The apparatus then uses the modified copies received from the user clients to update the list of changes of the respective user client or user. Other users can view the changes, e.g., in real time. In some instances, a user may be allowed to watch other users editing the content. For example, user A can connect to the apparatus and view the changes performed by user B, and he/she can view the changes that user C is making due to the live update.

The list of changes of the different users or user clients are then integrated by the lead user. Possible conflicts of multiple modifications that cannot be integrated together are resolved by the lead user as manual integrations of individual modifications, or as group integrations, i.e., many modifications together.

To keep modifications of single assets intact, especially if they are in relation to other objects, these assets can be linked to other assets (creation of a parent/child relation) in a hierarchical order to keep the content intact.

Modifications may be saved as a list of changes. The lists of changes may include the modifications carried out by one of the user clients, or references to these modifications, possibly including additional information. Objects affected by these changes are not locked by the apparatus, but tracked as lists of changes (or change histories) and linked to specific users or user clients. Thus, each user or user client may have its own list of changes. The lead user can then approve or disapprove changes user by user, or also based on time or location in the content. A typical case would be that user A has the task to update all vehicles in a given content. These changes can then be approved by the lead, independently from any changes done to these vehicles by other users, as this task was clearly assigned to user A. Accepting the modifications from user A also rejects modifications of other users that are conflicting (these can be automatically rejected or manually rejected). Inside a list of change, the changed objects may be gathered as layers, e.g., lighting objects may be summarized as a lighting object layer list of changes, again also indexed by the user who changed them, automatically.

In some embodiments, the lead user does not have to approve all changes manually. For example, the system may identify the conflict (e.g., one object changed in more than one change list) and highlight these for manual approval. The lead user is supported, as he can automatically approve all objects or modifications of a certain layer by one user, e.g., all light object changes done by user A may be approved.

With this method, it is possible that users modify data based on unapproved data. These cases can either be prohibited by the lead (to be set in the general settings), or marked as such to allow the lead to approve such changes together.

The lead user may be a user that is in charge of several other users or editors. His or her task may be to resolve conflicting modifications and to approve or disapprove all submitted modifications.

The approval process is supported by (1) a list of changes that can be sorted and filtered by several means, such as user, user client, time, location, layer of content, and others, and (2) highlighting the modifications inside an editing application used to modify the content.

The list of changes and the editor are interconnected, such that the lead can click on a change of the list of changes and can instantly see the modified copy or asset in the editing application.

While the list of changes is an overview over all applied changes, it does not show the real impact of the modification in detail when observed in an overview inside the editing application. By viewing the modified asset or a copy of the content in the editing program, the lead is able to decide if the modification is to be approved or not.

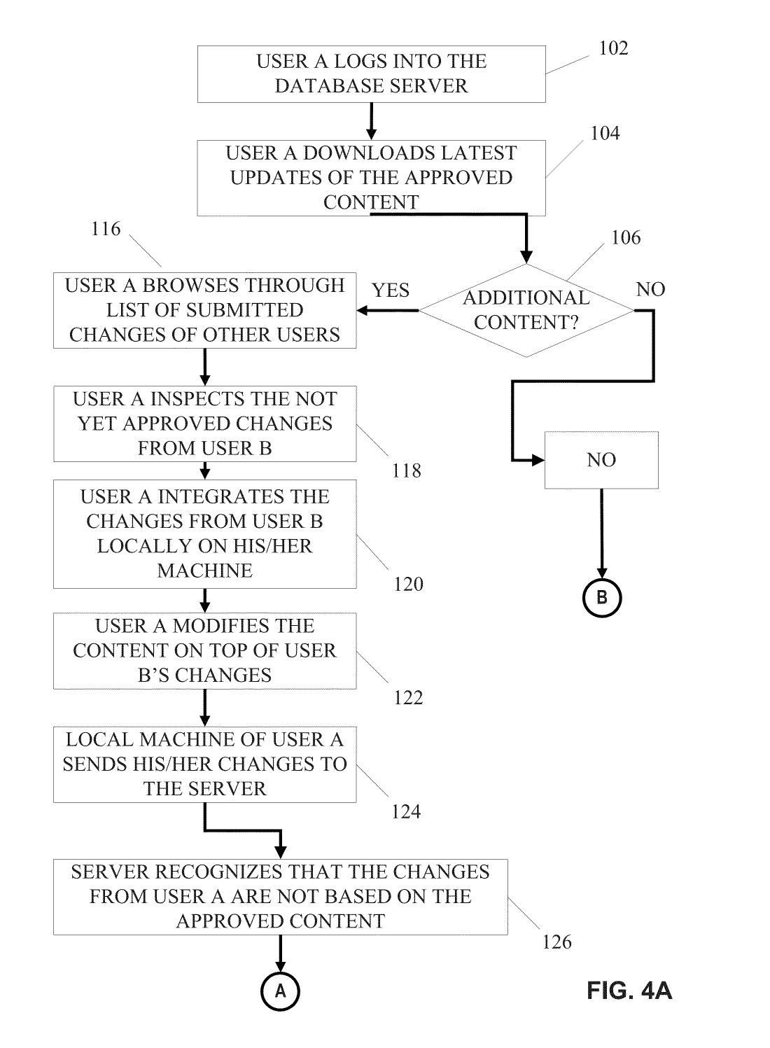

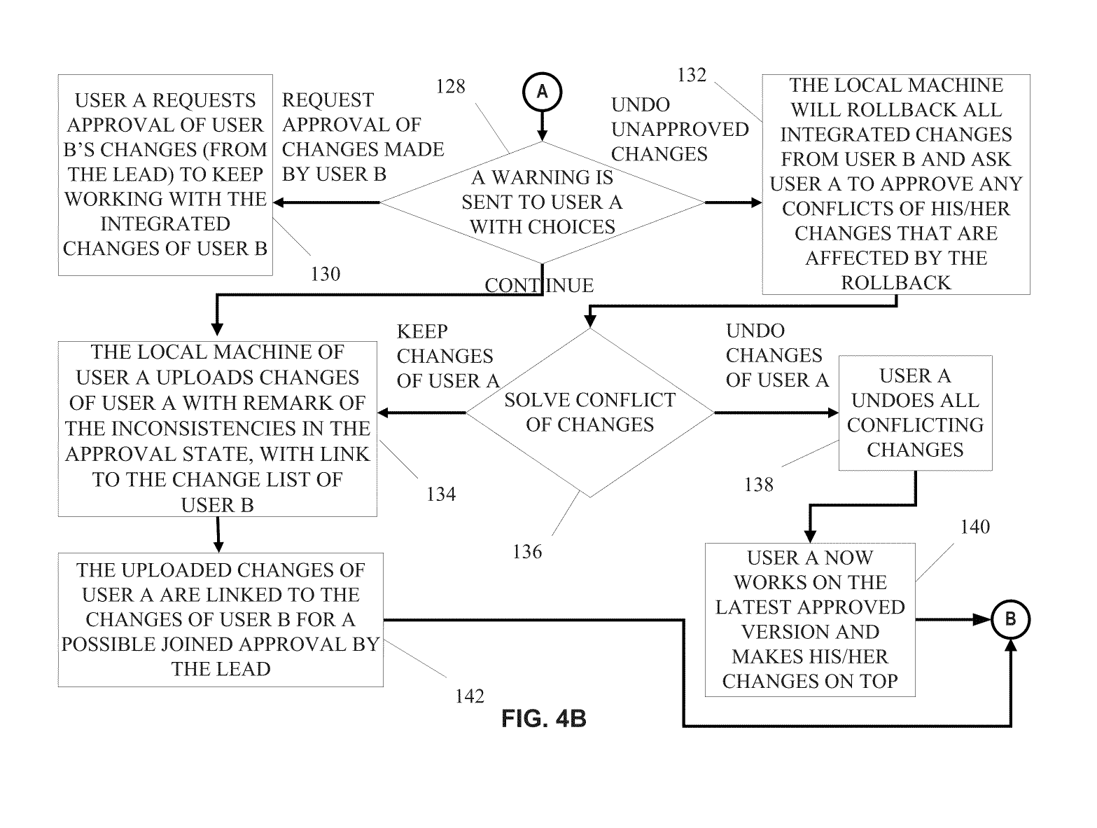

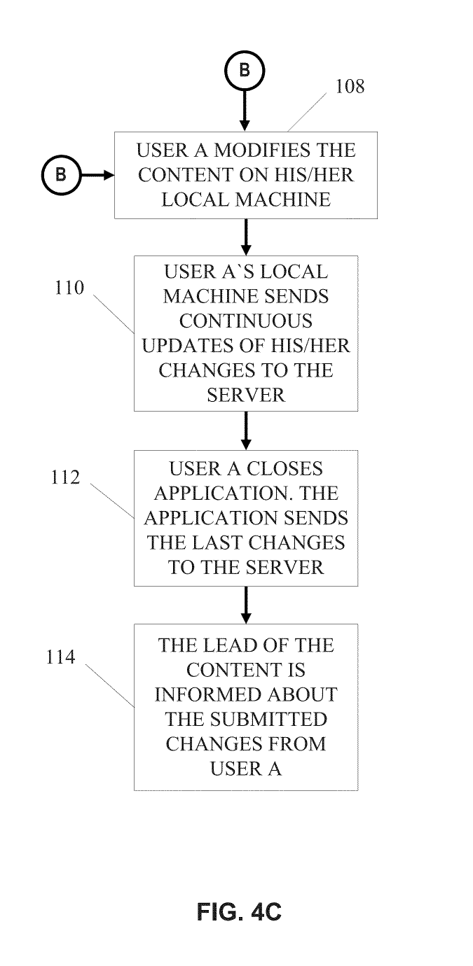

FIGS. 4A-C show a flow chart illustrating a method according to an embodiment showing how a user A operating a user client is able to modify a data portion that is located in the memory of an apparatus without the necessity to request exclusive rights to modify the data portion. To enhance legibility, the flow chart has been distributed over three figures.

The method starts at block 102, when user A logs into the database server, using a user client.

When user A has logged into the database server, user A downloads the latest updates on the approved content in block 104. In other words, when user A logs into the database server, the database server transmits a copy of a requested data portion of the CG content to the user client operated by user A.

The method then continues to block 106, where it is determined whether there is additional content available for the requested data portion in the list of changes. If there is no additional content, in block 108, user A may modify the content, i.e., the local copy of the data portion on his/her user client.

While user A works on the local copy of the data portion, user A's user client continuously sends updates of the modifications to the server at block 110. When user A closes the application for modifying the data portion on his/her user client, in block 112, the application sends the last modifications to the server. Subsequently, at block 114, the lead is informed about the modifications received from user A.

If, at block 106, it is determined that additional content is available for the requested data portion in the list of changes, at block 116, user A may browse through the list of submitted changes of the other users. In block 118, user A may then inspect the not-yet-approved changes from user B, as included in the list of changes.

In block 120, user A may then integrate the changes from user B locally on user A's user client. In block 122, user A may then modify the data portion on top of the changes previously performed by user B.

In block 124, the user client of user A sends the modifications performed by user A to the server. In block 126, the server recognizes that the modifications from user A are not based on the approved content, but have been performed on top of user B's changes. Subsequently, in block 128, a warning is sent from the server to user A, providing user A with choices. Selecting a first option, user A may request an approval of the modifications by user B from the lead user, to keep working with the integrated modifications of user B, in block 130. The request for approval may then be forwarded to the lead user with high priority.

As a second option, user A may choose to undo all changes from user B that have not yet been approved. Following this option, in block 132, the user client of user A will rollback all integrated modifications from user B and ask user A to approve any conflicts of his/her modifications that are affected by the rollback. In case conflicts have been determined, in block 136, the conflicts may be resolved by keeping the changes of user A or by undoing the changes of user A. In case the changes of user A are kept, the method continues with block 134, where user A's user client uploads the modifications by user A with a remark of the conflicts or inconsistencies with the approved state, and, possibly, with the link to the list of changes of user B. Equivalently, when user A in block 128 chooses to continue work anyway, the method also proceeds to block 134.

In case, in block 136, it has been determined that the conflict is to be resolved by undoing the changes of user A, in block 138, user A can undo all conflicting changes. Subsequently, in block 140, user A then works on the latest approved version plus adds user A's own changes on top of it. The method then proceeds to block 108.

When, in block 134, the changes, i.e., modifications, by user A have been uploaded with a remark of the conflicts and inconsistencies with the approved state, the uploaded changes of user A are linked to the list of changes of user B for a possible joint approval by the lead in block 142. The method then proceeds to block 108.

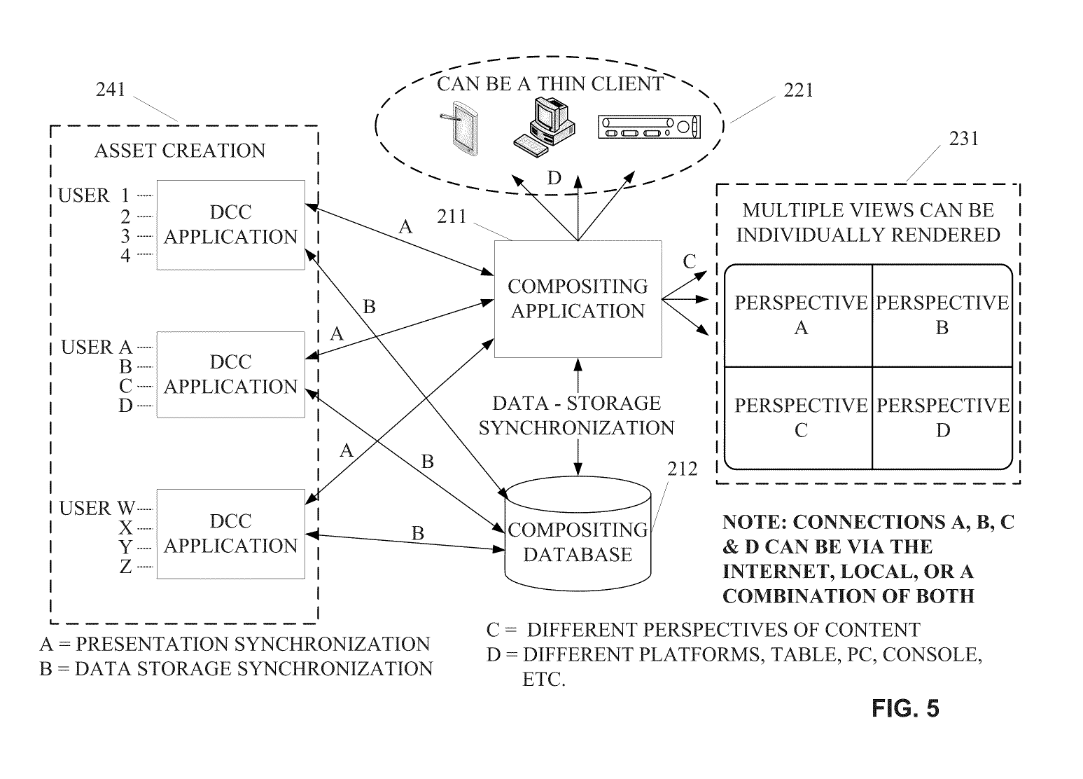

FIG. 5 is a schematic view of a system according to a further embodiment. The system illustrated in FIG. 5 comprises a compositing application 211 coupled to a compositing database 212 for data storage synchronization. The compositing application 211 may be coupled to one or more user clients, generally indicated by reference numeral 221 in FIG. 5, which may, e.g., comprise a thin client or a gaming console. Moreover, the compositing application 211 is also coupled to a number of different viewing clients, generally indicated by reference numeral 231 in FIG. 5. Using the compositing application 211, the viewing clients 231 may select one of different views or perspectives, indicated by perspectives A-D in FIG. 5.

The compositing application 211 and the compositing database 212 are further connected to an asset creation system 241, comprising a number of DCC applications and users. The application may interact with the compositing database and the compositing application to receive copies of one or more data portions of the computer-generated content. Moreover, the DCC applications of the asset creation system 241 may upload modified copies to the compositing application 211. The uploaded modified copies may then be used to update the data of the computer-generated content stored in the compositing data base 211, e.g., based on an approval by a lead user.

Many variations, substitutions and changes of the described embodiments will become apparent to the skilled person when reading the foregoing specification, and are intended to be included in the scope of the disclosure as set forth in the accompanying claims. For example, the computer-generated content may be content, such as a scene of a computer game, an animation, or a movie. In particular, the computer-generated content may refer to a game level of a computer game, such as, e.g., an online computer game. Additionally or alternatively, one or more of the clients, such as user clients or viewing clients, may comprise different types of displays, such as one or more LCD displays, LED displays, CRT displays, touch sensitive displays, projectors, etc. The features of the present invention disclosed in the specification, the claims and/or in the accompanying drawings may, separately or in combination, be material for realizing the invention in various forms.

The embodiments of the invention in which an exclusive property or privilege is claimed are defined as follows:

1. An apparatus for allowing a plurality of users to modify computer-generated content, comprising:
an I/O adapter configured to couple to at least first and second user clients;
a memory configured to store data of the computer-generated content; and
circuitry operatively coupled to the I/O adapter and the memory, wherein the circuitry is configured to transmit a first copy of a portion of the stored data of the computer-generated content to the first user client and a second copy of the portion to the second user client, such that the first and second user clients can modify the first and second copy of the portion, respectively, at the same time and independently from each other, receive a modified first copy from the first user client and a modified second copy from the second user client, and update the data of the computer-generated content stored in the memory using the modified first and second copies.

2. The apparatus of claim 1, wherein the data of the computer-generated content stored in the memory includes at least one list of changes, and wherein the circuitry is further configured, in response to receiving the modified first copy from the first user client and before receiving the modified second copy from the second user client, update the at least one list of changes using the received modified first copy, and transmit a notification to the second user client that the modified first copy of the portion of data has been received from the first user client.

3. The apparatus of claim 2, wherein the circuitry is further configured, in response to transmitting the notification to the second user client, to receive confirmation information regarding the modified first copy from the second user client, and to store the received confirmation information in the at least one list of changes.

4. The apparatus of claim 3, wherein the I/O adapter is further configured to couple to a lead user client, and wherein the circuitry is further configured to transmit the at least one list of changes to the lead user client and, in response to receiving an approval indication for at least a part of the at least one list of changes from the lead user client, update the portion of the data of the computer-generated content stored in the memory based on the approval indication.

5. The apparatus of claim 1, wherein the first copy of the portion of data transmitted to the first user client corresponds to a first perspective and wherein the second copy of the portion of data transmitted to the second user client corresponds to a second perspective different from the first perspective.

6. The apparatus of claim 1, wherein the I/O adapter is further configured to couple to at least first and second viewing clients, and wherein the circuitry is further configured to transmit a third copy of the portion of data corresponding to a third perspective to the first viewing client, and a fourth copy of the portion of data corresponding to a fourth perspective different from the third perspective to the second viewing client.

7. The apparatus of claim 1, wherein the circuitry is configured to transmit the first and second copies in a platform-independent format.

8. The apparatus of claim 1, wherein the first copy is transmitted to the first user client prior to transmitting the second copy to the second user client, and wherein the circuitry is further configured to transmit, along with the second copy, an indication to the second user client that a layer of the second copy may not be modified by the second user client.

9. The apparatus of claim 8, wherein the layer corresponds to at least one of character data; vfx data, audio data, metadata, editorial data, and environmental data.

10. The apparatus of claim 1, wherein the circuitry is configured to transmit the first and second copies of the portion of data in a 3D format.

11. A non-transitory, machine-readable medium having instructions stored thereon that, when executed by a machine, cause the machine to perform a method comprising:
transmitting a first copy of a portion of data of computer-generated content stored in a memory to a first user client and a second copy of the portion to a second user client, such that the first and second user clients can modify the first and second copy of the portion, respectively, at the same time and independently from each other;
receiving a modified first copy from the first user client and a modified second copy from the second user client; and
updating the data stored in the memory using the modified first and second copies.

12. The non-transitory, machine-readable medium of claim 11, wherein the data of the computer-generated content stored in the memory includes at least one list of changes, and wherein the method further comprises:
in response to receiving the modified first copy from the first user client and before receiving the modified second copy from the second user client, updating the at least one list of changes using the received modified first copy; and
transmitting a notification to the second user client that the modified first copy of the portion of data has been received from the first user client.

13. The non-transitory, machine-readable medium of claim 12, wherein the method further comprises:
in response to transmitting the notification to the second user client, receiving confirmation information regarding the modified first copy from the second user client; and
storing the received confirmation information in the at least one list of changes.

14. The non-transitory, machine-readable medium of claim 13, wherein the method further comprises:
transmitting the at least one list of changes to a lead user client; and
in response to receiving an approval indication for at least a part of the at least one list from the lead user client, updating the portion of the data of the computer-generated content stored in the memory based on the approval indication.

15. The non-transitory, machine-readable medium of claim 11, wherein the first copy of the portion of data transmitted to the first user client corresponds to a first perspective and wherein the second copy of the portion of data transmitted to the second user client corresponds to a second perspective different from the first perspective.

16. The non-transitory, machine-readable medium of claim 11, wherein the method further comprises:
transmitting a third copy of the portion corresponding to a third perspective to a first viewing client, and a fourth copy of the portion corresponding to a fourth perspective different from the third perspective to a second viewing client.

17. The non-transitory, machine-readable medium of claim 11, wherein the first and second copies are transmitted in a platform-independent format.

18. The non-transitory, machine-readable medium of claim 11, wherein the first copy is transmitted to the first user client prior to transmitting the second copy to the second user client, and wherein the method further comprises:
transmitting, along with the second copy, an indication to the second user client that a layer of the second copy may not be modified by the second user client.

19. The non-transitory, machine-readable medium of claim 18, wherein the layer corresponds to at least one of character data, vfx data, audio data, metadata, editorial data, and environmental data.

20. A system comprising the apparatus of claim 1 and at least a first and a second user client coupled to the I/O adapter of the apparatus.
